(19) United States
(12) Patent Application Publication
(10) Pub. No.: US 2006/0118471 A1
(43) Pub. Date: Jun. 8, 2006

(54) Stackable chromatography module, and chromatography column comprising a stack of said modules

(75) Inventor: Pierre Vidalinc, Chaptuzat (FR)

Correspondence Address: NIXON & VANDERHYE, PC, 901 NORTH GLEBE ROAD, 11TH FLOOR, ARLINGTON, VA, 22203, US

(73) Assignee: BIO-RAD PASTEUR, MARNES-LA-COQUETTE (FR)

(21) Appl. No.: 11/266,493

(22) Filed: Nov. 4, 2005

Related U.S. Application Data
(63) Continuation of application No. PCT/FR04/02837, filed on Nov. 4, 2004.

(51) Int. Cl. B01D 15/08

(52) U.S. Cl. 210/198.2

(57) ABSTRACT

The invention proposes a liquid phase chromatography module (1) comprising:
a container (2) having an upper end (4) and a lower end (5) which are open and have complementary shapes;
a chromatographic mixture (9) in the container (2);
a filtering membrane (10) fixedly disposed at one end (5) of the container (2).

The invention also proposes a chromatography column comprising a stack of said modules (1) fitted together.

### FIELD OF THE INVENTION

The invention relates to liquid phase chromatography.

### BACKGROUND OF THE INVENTION

Liquid phase chromatography is conventionally carried out in a column containing a chromatographic mixture comprising, for example, a gel constituted by microparticles in suspension in a buffer solution contained in a cylindrical tube which is supplied with liquid to be chromatographed, said liquid then being recovered at the column outlet.

That proven technique suffers from a certain number of disadvantages. Firstly, the chromatography columns are bulky, expensive installations. Because of their capacity, filling them involves handling large quantities of chromatographic mixture, which has to be stored both before and after use.

Attempts have been made to find alternatives to such columns. Reference may in particular be made to published French patent application FR-A-2 645 965, which proposes a modular chromatography device constituted by a juxtaposition of chromatography modules into each of which the liquid to be chromatographed is introduced under pressure.

The technical solution proposed by that document is not entirely satisfactory, however. The chromatography modules described are relatively complex to produce. Further, the structure of the device poses problems regarding supply and distribution of the liquid to be chromatographed between the juxtaposed modules. Further, the complex path followed by the liquid to be chromatographed limits the throughput of the device.

The aim of the invention is to overcome the disadvantages cited above by proposing a chromatography module which can facilitate assembly and dismantling of the chromatography column while guaranteeing high quality chromatography.

### DETAILED DESCRIPTION OF THE INVENTION

To this end, the invention proposes a chromatography module comprising:
a container having an upper end and a lower end;
a chromatographic mixture in the container;
a filtering membrane disposed at one end of the container;

said module being characterized in that the ends of the container are open and have complementary shapes, and in that the filtering membrane is fixed to the lower end of the container.

Such a module, which is easy to handle, allows direct storage of the chromatographic mixture. Because it fits directly on an identical module, its structure means that a chromatography column can be produced wherein the chromatographic mixture, which is monoblock, enables chromatography to be carried out in a single step.

The invention also provides a chromatography column comprising a stack of said modules fitted together.

Further aims and advantages of the invention will become apparent from the description below made with reference to the accompanying drawings in which:

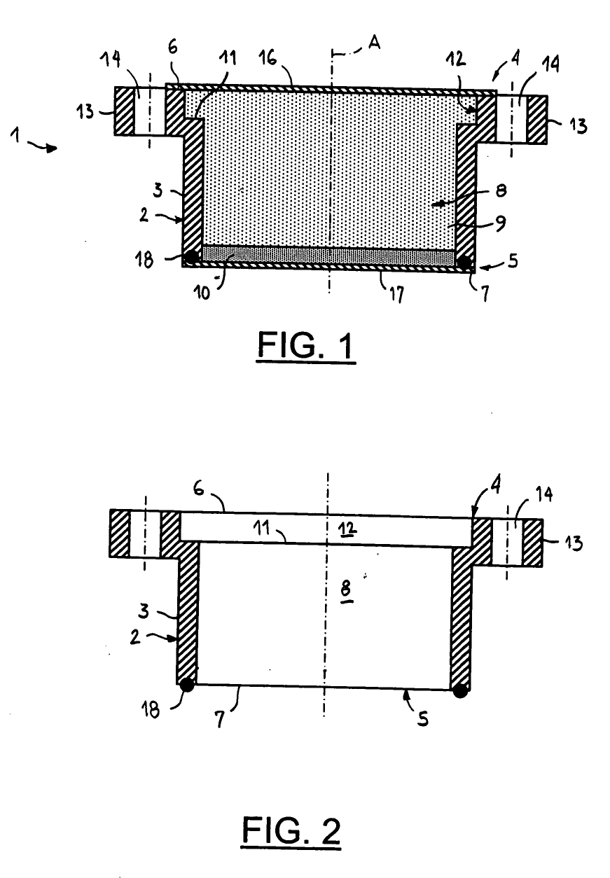

FIG. 1 is a sectional side view showing a chromatography module of the invention;

FIG. 2 is a sectional side view of a container for a chromatography module as shown in FIG. 1;

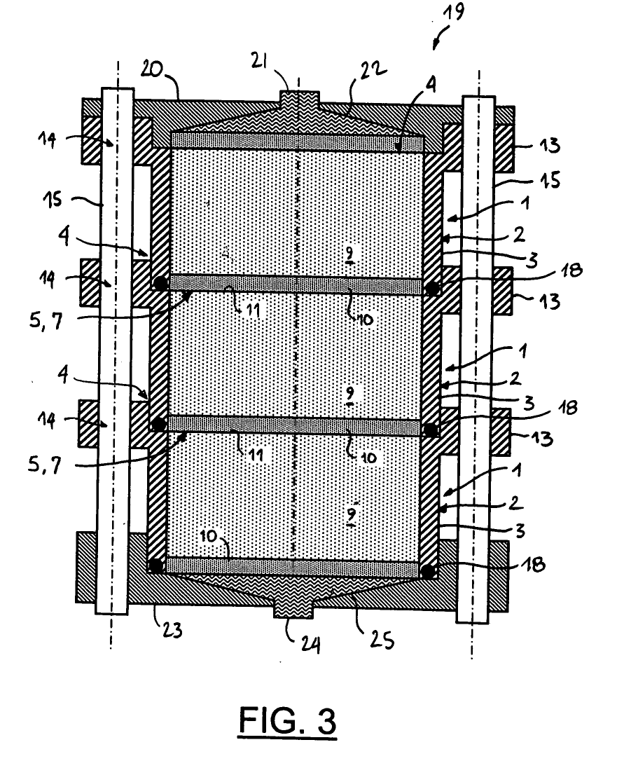

FIG. 3 is a sectional side view of a chromatography column of the invention, formed by stacking chromatography modules such as those shown in FIG. 1.

FIG. 1 shows a chromatography module 1.

Said module 1 comprises a container 2, shown alone in FIG. 2, which comprises a cylindrical side wall 3 having rotational symmetry about a central axis A. Said rotational symmetry, by means of which the side wall 3 has a circular cross section, is not a necessity; any type of cross section (square, rectangular, oval, etc) may be envisaged.

The container 2, preferably produced from a plastic material such as polypropylene, has an upper end 4 and a lower end 5, both open, each formed by a circular free edge, an upper edge 6 and lower edge 7 respectively.

Between its ends 4, 5, the container 2 defines a chamber 8 with volume V1, in which a chromatographic mixture 9 (also termed the stationary phase) is received comprising, for example, a chromatographic gel constituted by microparticles (such as microspheres) in suspension in a buffer solution, for example in a ratio of 1:1 (i.e. one kilogram of microparticles per 1 litre of buffer solution).

A filter membrane 10 the diameter of which corresponds to the internal diameter of the wall 3 is fixed to the lower end 5 of the container 2. Said membrane 10, produced from polyethylene, for example, has a porous structure and guarantees retention of the chromatographic mixture 9 in the container 2.

As can be seen in FIGS. 1 and 2, the container 2 has, to the side of the upper end 4, a shoulder 11 disposed at a certain distance from the upper edge 4, to form a countersink 12 the internal diameter of which corresponds to the external diameter of the container 2 at its lower end 5.

In the chamber 8, the countersink 12 has a secondary volume V2 determined as a function of the compressibility of the chromatographic mixture 9 and the desired final pressure thereof, as will become apparent below.

The ends 4, 5 of the container thus have complementary shapes, so that it is possible to stack several modules 1 by fitting them one into another by inserting the lower end 5 of a first module 1 into the upper end 4 of a second module 1 until the lower edge 7 of the first abuts against the shoulder 11 of the second.

We shall discuss the advantages of such a disposition below.

As can be seen in FIG. 1, to the side of its upper end 5, the container 2 has a collar 13 (or lugs) which project radially, in which are formed a plurality of axial openings 14 to allow connecting rods 15 to be introduced, as will be discussed below.

Once the mixture 9 has been introduced into the container 2, it is sealed by means of two films 16, 17 formed from plastics material, one of which, 16, covers the upper end 4 and the other of which, 17, covers the lower end 5.

Further, a rubber O-ring 18 is placed at the lower end 5 of the container 2. Although not clearly visible in the figures, said ring 18 may be fixed in an annular groove provided in the lower edge 7 of the container 2; the O-ring extends slightly out of the groove to allow it to be compressed when stacking the module 1.

Regarding the dimensions, the module 1 has a thickness—i.e. the distance separating its edges 6, 7—in the range 50 mm [millimeters] to 100 mm, while its diameter (i.e. the external diameter of the wall) is in the range 100 mm to 2000 mm. The example illustrated shows a relatively “square” module 1, but it may also be more flattened, whereupon its diameter will be much larger than its thickness.

Module 1 is constituted as follows.

Starting from the container 2, the O-ring 18 is attached along with the membrane 10 at its lower end 5. The chromatographic mixture is then introduced under pressure so that the mixture 9 is level with the upper edge 6 without overflowing, however. The container 2 is then sealed using films 16, 17 disposed on the upper 4 and lower 5 edges. The pressure of the chromatographic mixture 9 in the module 1 is P1.

A chromatography column 19 is shown in FIG. 3. Said column 19 comprises a stack of chromatographic modules 1 such as that shown above, nested one in the other in the manner described above.

Either side of the modules 1, column 19 comprises two closing plates, namely:
firstly, an upper plate 20 mounted on the last module at the upper end of the stack, said plate being provided with an orifice 21 for supplying the column 19 with liquid to be chromatographed—also termed the mobile phase—and a nozzle 22 connected to said orifice, to distribute the liquid to be chromatographed over the whole surface of the upper end 4 of the module 1, and
a lower plate 23 mounted on the last module at the lower end of the stack, said plate 23 also being provided with an orifice 24 for evacuating chromatographed liquid from the column 19, and a nozzle connected to said orifice 24 to direct the liquid towards it.

When stacking the chromatographic modules 1, the lower end 5 of an upper module 1 is introduced into the upper end 4 of a lower module 1, after removing films 16, 17. It is easy to understand that said introduction tends to compress the chromatographic mixture 9 of the lower module 1 the secondary volume V2 of which, previously occupied by the mixture 9, is, in the end, occupied by the fitted portion of the upper module 1. Because of the nature of the chromatographic mixture 9 (we saw above that it is a gel), such compression can only occur by forced fitting.

For this reason, to keep the stack together, connecting rods 15 (made in the shape of threaded rods) are introduced into the openings, bolts (not shown) then being screwed onto the ends of the connecting rods 15 to keep them fitted together.

Thus, the pressure in the chromatographic mixture 9 increases in proportion to the reduction in the volume occupied by the mixture 9. More precisely, if P2 is the pressure of the chromatographic mixture 9 in a stacked module 1, and if the thickness of the membrane 10 is ignored, the pressure P2 satisfies the following relationship:
P2/P1=(V1−V2)V1

It will be understood that adjusting the height of the countersink 12 can proportionately modify the final pressure of the chromatographic mixture 9 to adjust the flow rate in the column 19.

The liquid to be chromatographed, introduced via the upper plate 20, passes through all of the modules 1 in the stack in succession before being evacuated via the lower plate 23. The openings in modules 1 at their ends means that flow of the mobile phase is laminar in the stationary phase 9, while the membranes 10, which maintain the stationary phase in place in each separate module do not oppose passage of the mobile phase. Thus, the conditions inside the column are as if the stationary phase 9 were a monoblock.

Clearly, the chromatographic mixture 9 will be selected as a function of the type of chromatography which is to be carried out (ion exchange chromatography, gel filtration chromatography, hydrophobic chromatography, affinity chromatography, silica gel chromatography, etc), for example for protein filtration, purification or reagent preparation.

1. A liquid phase chromatography module comprising:
a container having an upper end and a lower end;
a chromatographic mixture in the container;
a filtering membrane disposed at one end of the container;
said module being characterized in that the ends of the container are open and have complementary shapes, and in that the membrane is fixed to the lower end of the container.

2. A chromatography module according to claim 1, in which the upper end of the container has a countersink for receiving and fitting the lower end of the container of an identical module.

3. A chromatography module according to claim 1, which further comprises a sealed film disposed at each end of the container.

4. A chromatography module according to claim 1, in which the upper end of the container has a countersink for receiving and fitting the lower end of the container of an identical module, and which also comprises a sealed film disposed at each end of the container.

5. A chromatography module according to claim 1, which comprises openings for the passage of connecting rods.

6. A chromatography module according to claim 1, in which in which the upper end of the container has a countersink for receiving and fitting the lower end of the container of an identical module, and which also comprises a sealed film disposed at each end of the container and which comprises openings for the passage of connecting rods.

7. A chromatography module according to claim 1, which comprises an O-ring disposed at the lower end of the container.

8. A chromatography module according to claim 1, in which the chromatographic mixture comprises a chromatographic gel constituted by microparticles in suspension in a buffer solution.

9. A chromatography module according to claim 1, in which the thickness of the container is in the range 50 mm to 100 mm, and the diameter is in the range 100 mm to 2000 mm.

10. A chromatography column comprising a stack of modules according to claim 1 fitted one in the other.

11. A chromatography column comprising a stack of modules according to claim 2 fitted one into another.

12. A chromatography column according to claim 10, the modules of which are compressed by means of connecting rods passing through the openings provided in the modules.

13. A chromatography column according to claim 10 which comprises two closing plates either side of the stack of modules, as follows:
an upper plate mounted on an upper module of the stack, said plate being provided with an orifice for supplying the column with liquid to be chromatographed and a nozzle to distribute liquid at the upper end of the module;
a lower plate mounted on a lower module of the stack, said plate being provided with an orifice for evacuating chromatographed liquid from the column, and a nozzle to direct the liquid for the evacuation orifice.
